(19) United States
(12) Patent Application Publication
(10) Pub. No.: US 2017/0068649 A1
(43) Pub. Date: Mar. 9, 2017

(54) METHOD AND APPARATUS FOR CAPTURING AND ORGANIZING MEDIA CONTENT

(71) Applicant: The STAU Group, Los Gatos, CA (US)

(72) Inventor: Lorenzo STAUNOVO POLACCO, Los Gatos, CA (US)

(21) Appl. No.: 14/849,206

(22) Filed: Sep. 9, 2015

(51) Int. Cl. G06F 17/24; H04L 29/06; G06F 17/30; H04L 29/08

(52) U.S. Cl. CPC G06F 17/241; H04L 67/02; H04L 65/403; G06F 17/30896

(57) ABSTRACT

A method and apparatus may include receiving a request from a user to capture a portion of electronic media content from an electronic document. The method may also include capturing the portion of the electronic media content. The method may also include determining metadata of the electronic document that corresponds to the portion of captured electronic media content. The method may also include automatically generating a citation for the captured electronic media content based on the determined metadata. The citation comprises at least one of a title of the captured electronic media content, an author of the captured electronic media content, and a date of the captured electronic media content.

### BACKGROUND

Field

Some embodiments of the present invention may generally relate to capturing and organizing of media content.

Description of the Related Art

Currently, a wide variety of media content can be created, viewed, distributed, and edited using computing devices. In the course of viewing media content, a user may wish to capture certain portions of the viewed media content for later retrieval. The user may store a reproduction of the viewed media content in the form of a separate, individual file or within a larger compilation of stored content.

### SUMMARY

According to a first embodiment, a method may include receiving, by a processor, a request from a user to capture a portion of electronic media content from an electronic document. The method may also include capturing the portion of the electronic media content. The method may also include determining metadata of the electronic document that corresponds to the portion of captured electronic media content. The method may also include automatically generating a citation for the captured electronic media content based on the determined metadata. The citation comprises at least one of a title of the captured electronic media content, an author of the captured electronic media content, and a date of the captured electronic media content.

In the method of the first embodiment, the receiving a request to capture a portion of electronic media content comprises receiving a request to capture the portion of electronic media content from a webpage. The metadata of the webpage comprises source code of the webpage.

In the method of the first embodiment, the title of the captured electronic media content is determined by first referencing <title> metadata, the author of the captured electronic media content is determined by first referencing author:name metadata, and the date of the captured electronic media content is determined by first referencing datePublished content=date metadata.

In the method of the first embodiment, the method may also include displaying the captured electronic media content. The method may also include displaying the automatically generated citation.

In the method of the first embodiment, the method may also include storing the captured electronic media content in one collection of a plurality of collections. Each collection is associated with a corresponding image.

In the method of the first embodiment, the method further comprises sharing at least one collection of the plurality of collections to at least one other user.

According to a second embodiment, an apparatus may include at least one processor. The apparatus may also include at least one memory including computer program code. The at least one memory and the computer program code may be configured, with the at least one processor, to cause the apparatus at least to receive a request from a user to capture a portion of electronic media content from an electronic document. The apparatus may also be caused to capture the portion of the electronic media content. The apparatus may also be caused to determine metadata of the electronic document that corresponds to the portion of captured electronic media content. The apparatus may also be caused to automatically generate a citation for the captured electronic media content based on the determined metadata. The citation comprises at least one of a title of the captured electronic media content, an author of the captured electronic media content, and a date of the captured electronic media content.

In the apparatus of the second embodiment, the receiving a request to capture a portion of electronic media content comprises receiving a request to capture the portion of electronic media content from a webpage. The metadata of the webpage comprises source code of the webpage.

In the apparatus of the second embodiment, the title of the captured electronic media content is determined by first referencing <title> metadata, the author of the captured electronic media content is determined by first referencing author:name metadata, and the date of the captured electronic media content is determined by first referencing datePublished content=date metadata.

In the apparatus of the second embodiment, the apparatus is further caused to display the captured electronic media content. The apparatus is also caused to display the automatically generated citation.

In the apparatus of the second embodiment, the apparatus is further caused to store the captured electronic media content in one collection of a plurality of collections. Each collection is associated with a corresponding image.

In the apparatus of the second embodiment, the apparatus is further caused to share at least one collection of the plurality of collections to at least one other user.

According to a third embodiment, a computer program product may be embodied on a non-transitory computer readable medium. The computer program product may be configured to control a processor to perform a method. The method may include receiving, by a processor, a request from a user to capture a portion of electronic media content from an electronic document. The method may also include capturing the portion of the electronic media content. The method may also include determining metadata of the electronic document that corresponds to the portion of captured electronic media content. The method may also include automatically generating a citation for the captured electronic media content based on the determined metadata. The citation comprises at least one of a title of the captured electronic media content, an author of the captured electronic media content, and a date of the captured electronic media content.

In the computer program product of the third embodiment, the receiving a request to capture a portion of electronic media content comprises receiving a request to capture the portion of electronic media content from a webpage. The metadata of the webpage comprises source code of the webpage.

In the computer program product of the third embodiment, the title of the captured electronic media content is determined by first referencing <title> metadata, the author of the captured electronic media content is determined by first referencing author:name metadata, and the date of the captured electronic media content is determined by first referencing datePublished content=date metadata.

In the computer program product of the third embodiment, the method may also include displaying the captured electronic media content. The method may also include displaying the automatically generated citation.

In the computer program product of the third embodiment, the method may also include storing the captured electronic media content in one collection of a plurality of collections, wherein each collection is associated with a corresponding image.

In the computer program product of the third embodiment, the method may also include sharing at least one collection of the plurality of collections to at least one other user.

### BRIEF DESCRIPTION OF THE DRAWINGS

For proper understanding of the invention, reference should be made to the accompanying drawings, wherein:

FIG. 1 illustrates creating a user account, in accordance with certain embodiments of the present invention.

FIG. 2 illustrates capturing an image, in accordance with certain embodiments of the present invention.

FIG. 3 illustrates capturing text, in accordance with certain embodiments of the present invention.

FIG. 4 illustrates capturing a Uniform Resource Locator (URL) of a webpage, in accordance with certain embodiments of the present invention.

FIG. 5 illustrates capturing the contents at a destination URL of a clickable link, in accordance with certain embodiments.

FIG. 6 illustrates an interface that identifies a captured webpage's title, from the webpage's metadata, in accordance with certain embodiments.

FIG. 7 illustrates how text can be captured, in accordance with certain embodiments.

FIG. 8 illustrates identifying an author, in accordance with certain embodiments of the present invention.

FIG. 9 illustrates identifying a publication date, in accordance with certain embodiments of the present invention.

FIG. 10 illustrates capturing/snagging an image from a blog, in accordance with certain embodiments.

FIG. 11 illustrates an example where no author can be found, in accordance with certain embodiments.

FIG. 12 illustrates an example where a publisher is identified, in accordance with certain embodiments.

FIG. 13 illustrates capturing/snagging a listing from a real estate website, in accordance with certain embodiments.

FIG. 14 illustrates identifying a document name of a real estate listing, in accordance with certain embodiments.

FIG. 15 illustrates an interface that enables a user to upload an image to a collection, in accordance with certain embodiments.

FIG. 16 illustrates an interface that allows a user to grab content and move the content to a collection, in accordance with certain embodiments of the present invention.

FIG. 17 illustrates an interface that enables a user to view a list of collections, that the user created or that were shared with the user, in accordance with certain embodiments.

FIG. 18 illustrates an interface that enables a user to upload content and create text posts, in accordance with certain embodiments.

FIG. 19 illustrates an interface that allows a user to share a collection with a group of other users, in accordance with certain embodiments of the present invention.

FIG. 20 illustrates a flowchart of a method in accordance with certain embodiments of the invention.

FIG. 21 illustrates an apparatus in accordance with certain embodiments of the invention.

FIG. 22 illustrates an apparatus in accordance with certain embodiments of the invention.

### DETAILED DESCRIPTION

Certain embodiments of the present invention are directed to a method and apparatus that may: (1) enable a user to seamlessly capture, store, and/or retrieve electronic media content, (2) generate/create citations for the captured content, (3) efficiently organize the captured content, and/or (4) enable sharing of a collection of captured content with others users. The electronic media content may be online content that is accessed via the internet, for example. Alternatively, the electronic media content may also be content from electronic documents that are not online documents.

As discussed above, certain embodiments may provide a first benefit of (1) enabling a user to seamlessly capture, store, and/or retrieve electronic media content. By using certain embodiments of the present invention, a user may capture electronic media content (from web pages, for example) in a convenient manner. For example, certain embodiments may allow a user to capture content by performing a single mouse/cursor click. The captured content may then be stored within a user account of the user, as described in more detail below. The user may subsequently retrieve and view the captured content via the user account in a seamless manner, as described in more detail below.

In the course of performing online research, a user may wish to quickly capture certain viewed content without interrupting the overall reviewing/researching process. For example, if the user is surfing the internet, the user may wish to capture content from a certain webpage without interrupting the overall process/flow of browsing/surfing through the webpages.

In one example, the user may be a student. If the student is performing online research for a school project, the student may browse through a large amount of online content by visiting a plurality of websites. The student may wish to capture certain content that is relevant to the student's research. For example, the student may wish to capture certain images, certain videos, certain links, and/or certain text that is related to the student's research.

However, with the previous approaches for capturing media content, the user would generally need to perform numerous steps in order to capture the desired content. Specifically, the previous approaches generally require multiple steps to capture the desired content, depending on the type of content that the user wishes to capture/save.

For example, in order to capture an image using the previous approaches, the user would generally need to perform the following steps: (1) right click on the image to be captured; (2) select “save image as” from a menu list; (3) enter a unique name for the image to be saved under; (4) choose the format (jpeg, gif, etc.) that the image is to be saved as; (5) choose a location where the image is to be saved to; and (6) click “Save” to finish saving the image.

In order to capture text using the previous approaches, the user would generally need to perform the following steps: (1) highlight the desired text to capture, (2) right click on the text to capture; (3) click “copy”; (4) navigate to a word processor or notebook application; (5) open the word processor/application, if the word processor/application is not already open; (6) right click within the word processor/application; and (7) click “Paste” to place the captured text within the word processor/application.

In order to capture video using the previous approaches, the user would generally need to perform the following steps: (1) right click on the video to be captured; (2) click “get embed code” or “get video URL”; (3) highlight and copy the code/uniform resource locator (URL); (4) navigate to a word processor, notebook, or HyperText Markup Language page; (5) open the word processor/notebook/HTML page, if the page is not already open; (6) right click within the page; and (7) click “paste” within the page.

As described above, each of the previous approaches for capturing the different types of media content were time-consuming and tedious. When the user/student performs the multiple steps of each of the previous approaches, the steps may distract the user from performing the overall research process. Further, with the previous approaches, in order to retrieve the captured content, the user would generally need to remember where the user previously saved the content, and remember the name that the content was previously saved under.

Further, with the previous approaches, when the user wants to review the saved/captured content, the user would generally need to open each file that the user has saved in order to review the content that is stored within each saved file. Again, performing this type of review using the previous approaches may be time consuming, distracting, and inefficient for the user.

In view of the above-described difficulties of the previous approaches, certain embodiments of the present invention may allow a user to easily capture content and to review the captured content. For example, with certain embodiments, a user may be able to capture content with a simple action (such as with a simple click, a tap, and/or a swipe, for example). Certain embodiments may allow a user to capture content with a single click.

Certain embodiments of the present invention may be implemented as a computer program product that enables a user to capture images, text, links, and/or videos with a simple action (such as with a single click, for example). Some embodiments may be implemented as a browser plugin. Other embodiments may be implemented as a stand-alone program. When a user decides to capture content, certain embodiments may allow the user to capture the content by storing a link to the content on a server, or by storing the content itself on the server.

Certain embodiments may also be implemented as a web application that allows a user to retrieve the captured content. The web application may allow a user to visualize the captured content. For example, the web application may be a webpage that displays/visualizes the captured content, and the user may visit the webpage to review the visualized captured content.

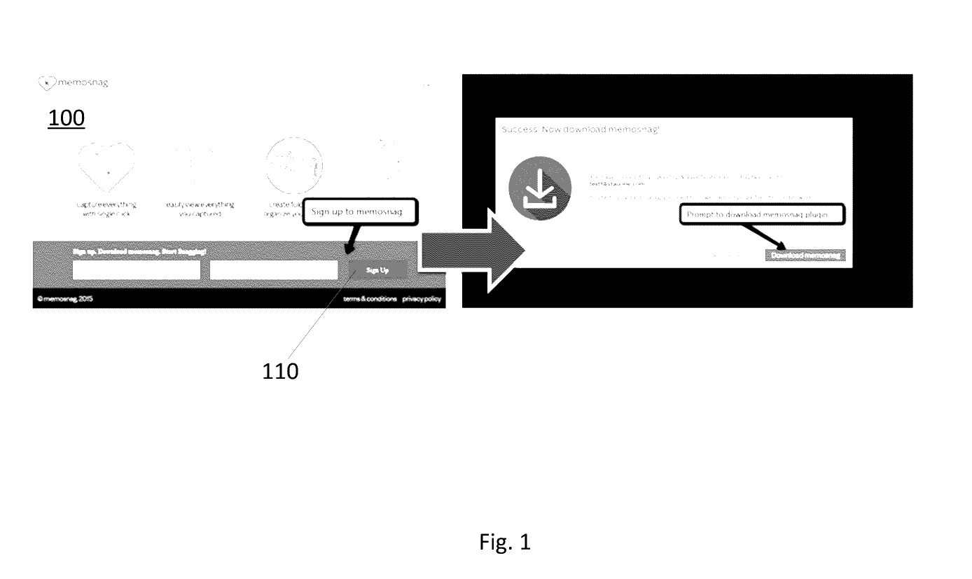

With certain embodiments, a user may create a user account (i.e., a “memosnag account.”) for capturing content and for reviewing the captured content. FIG. 1 illustrates an example interface for creating a user account, in accordance with an embodiment of the present invention. For example, interface 100 of FIG. 1 allows a user to enter an e-mail address and password for creating a user account. After entering the e-mail address and the password, the user may click button 110 to create the new user account.

After the user account is created, the user may be prompted to download a software application, such as the aforementioned browser plugin, for example. The plugin may be a browser extension that is specific for a browser and that is connected to the user's account, for example. The plugin may comprise a proprietary software application that enables recognition of different characteristics of content, as described in more detail below, and that utilizes functionalities provided by the browser.

Different types of content may be captured when the user performs specific corresponding user actions. For example, to capture an image, the user may move a pointer or cursor (such as a mouse cursor, for example) over the image. After the pointer/cursor is moved over the image, the file format and the object size of the image may be recognized/identified by certain embodiments of the invention.

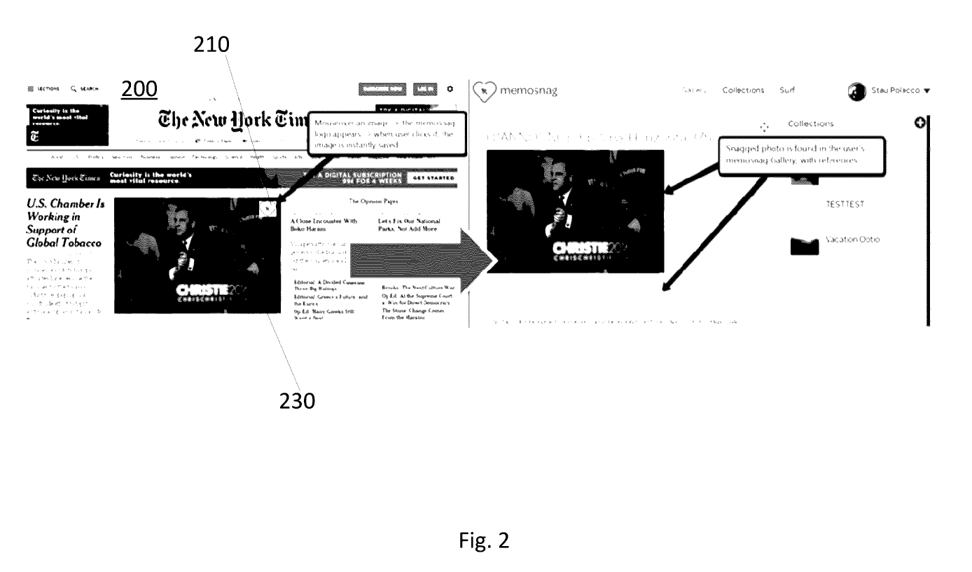

FIG. 2 illustrates an example of capturing an image, in accordance with an embodiment of the present invention. When capturing an image, certain embodiments receive a request from the user to capture the image from a webpage 200. For example, with certain embodiments, an icon 210 may appear on an image 230 to be captured, and the request to capture the image may occur when the user clicks the icon 210. When the user's cursor is placed over the image, the icon 210 may be highlighted, which indicates that image 230 is eligible to be captured. When the user clicks on the icon 210, the image's URL (or the image itself) may be automatically sent to a server and saved in the user's account. Some embodiments may also collect metadata relating to the webpage/document on which image 230 appears. This metadata may be used to generate a citation for the image, as described in more detail below. Image 230 is rendered in the user's personal account together with the citation. Although the process for capturing image 230 is specifically discussed above, other types of content may also be captured via a similar process by certain embodiments.

Certain embodiments of the present invention may prohibit the capturing of certain content. For example, some embodiments may maintain a site-exclusion list. If a website (i.e., an “excluded” website) is on the site-exclusion list, then a user will not be able to capture content from the excluded website. A website may be included on the site-exclusion list if the website is determined to include explicit material, discriminatory material, or any other type of material that is determined to be inappropriate, for example.

Further, a particular website may be included on the site-exclusion list if it is determined that a user is unlikely to want to capture content from the particular website. For example, as described above, a user may visit a website (that displays/visualizes the user's captured content) in order to review content that has been captured by the user. The user is generally unlikely to capture content from this web application/website itself because the web application/website is merely used to view the content which the user has already captured. Users are unlikely to want to capture content from the web application/website that they are using to view the already captured content. As such, certain embodiments may exclude the application/website that is used to retrieve/review the captured content. Thus, certain embodiments may avoid the possibility of capturing unwanted content, and may also avoid the possibility of bothering the user with unnecessary requests to capture content.

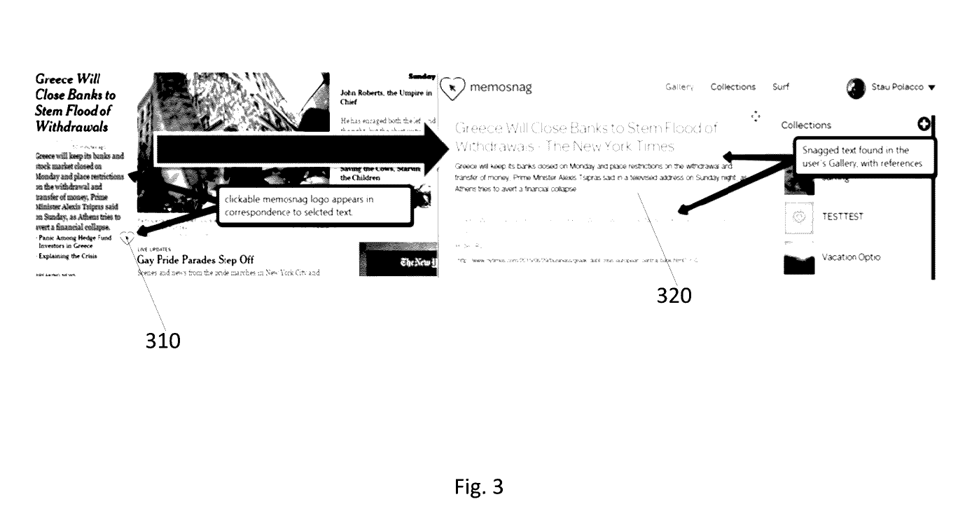

FIG. 3 illustrates an example of capturing text, in accordance with an embodiment of the present invention. When capturing text, a user may select the text. The text may be selected using a cursor, for example. The user may click and highlight the part of the text that the user is interested in. In certain embodiments, after the text is selected, an icon 310 may appear at the end of the selected text. The icon 310 may appear upon releasing the cursor click after selecting the text. Next, the user may click on the icon 310 that appears. When the user clicks on the icon 310, the selected text may be automatically transmitted to a server and saved in a user account of the user (within a gallery 320, for example).

With regard to capturing a Uniform Resource Locator (URL) of a webpage, a user may capture the URL of the webpage that the user is currently viewing. The user can capture the URL by right clicking anywhere in the page and requesting the capture. For example, the user may select “memosnag” and then “snag page.” When the user clicks on “snag page,” the memosnag application may take a screenshot (image) of the current page view and may send the screenshot to a server, together with the page's URL. Both the screenshot and the page's URL may be saved in the user's account. As described in more detail below, certain embodiments may also collect a part of the web page's metadata. The page title (derived from metadata “<title>,” for example) may be displayed in the user's personal account, together with the screenshot and with other citation information, which may be derived from the web page's metadata. The web page's URL may be embedded in the stored title so that, by clicking on the page title, a user may be redirected to the web page.

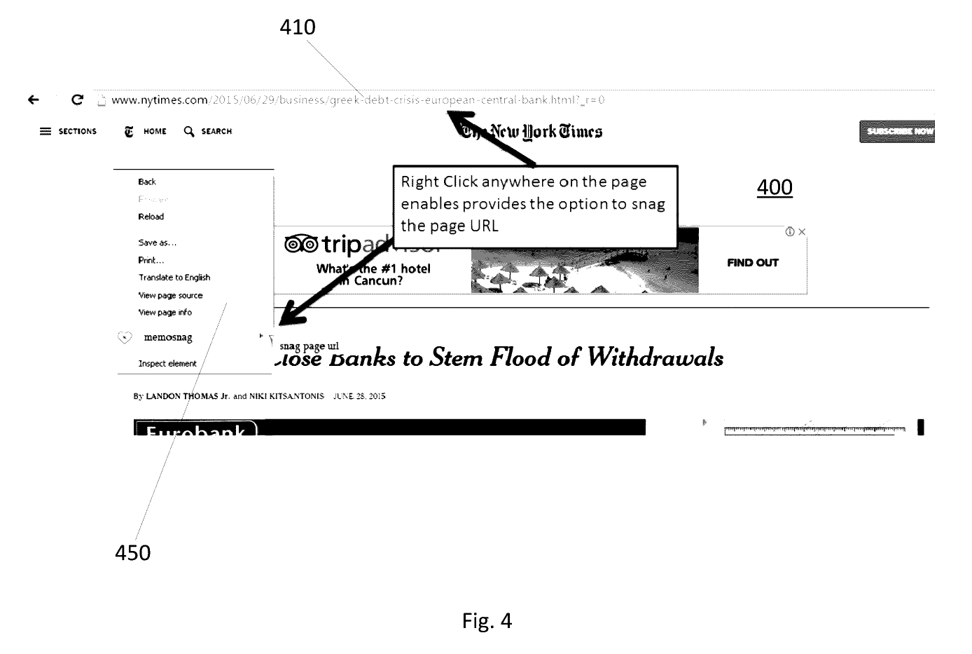

FIG. 4 illustrates an example of capturing a URL of a webpage in accordance with an embodiment of the present invention. By clicking anywhere on the webpage 400, the URL 410 of the webpage can be captured/snagged by the user.

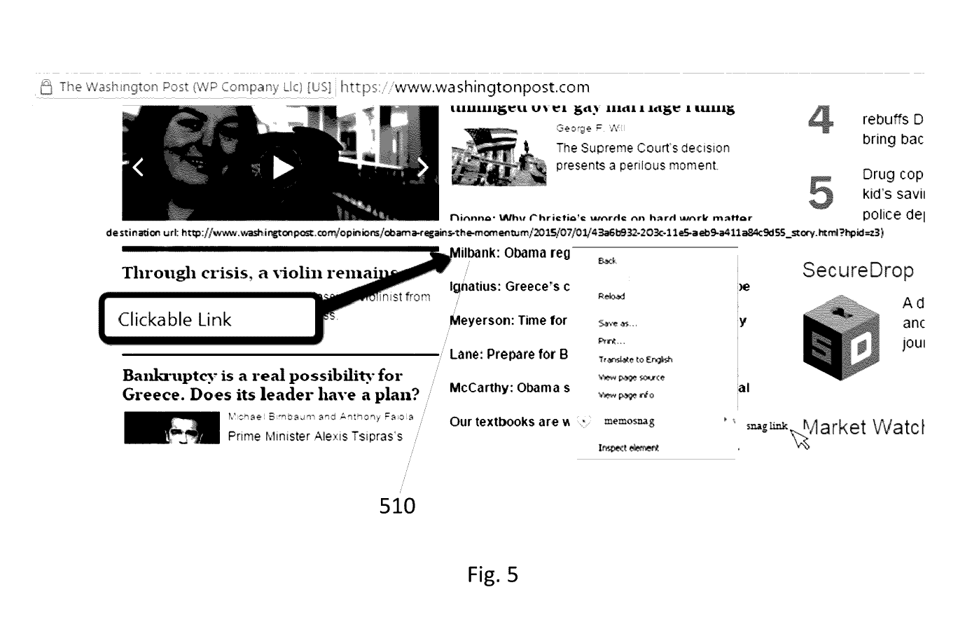

FIG. 5 illustrates an example of capturing the contents at a destination URL of a clickable link, in accordance with an embodiment. The destination URL that corresponds to a clickable link 510 may be captured by right clicking on the clickable link 510, and by issuing a request to capture (i.e., by selecting “memosnag” and “snag link”).

When the user requests capture of the clickable link, certain embodiments may open a webpage corresponding to the destination URL in a new window in the background. Certain embodiments may take a screenshot (image) of the webpage of the destination URL, may send the destination URL to a server, and may close the window. Both the screenshot and the destination page's URL may be saved in the user's account. Certain embodiments may also collect a part of the destination page's metadata. The destination page's title (from metadata <title>) may be displayed in the user's personal account, together with the screenshot and with the source information, which may be derived from the destination webpage's metadata.

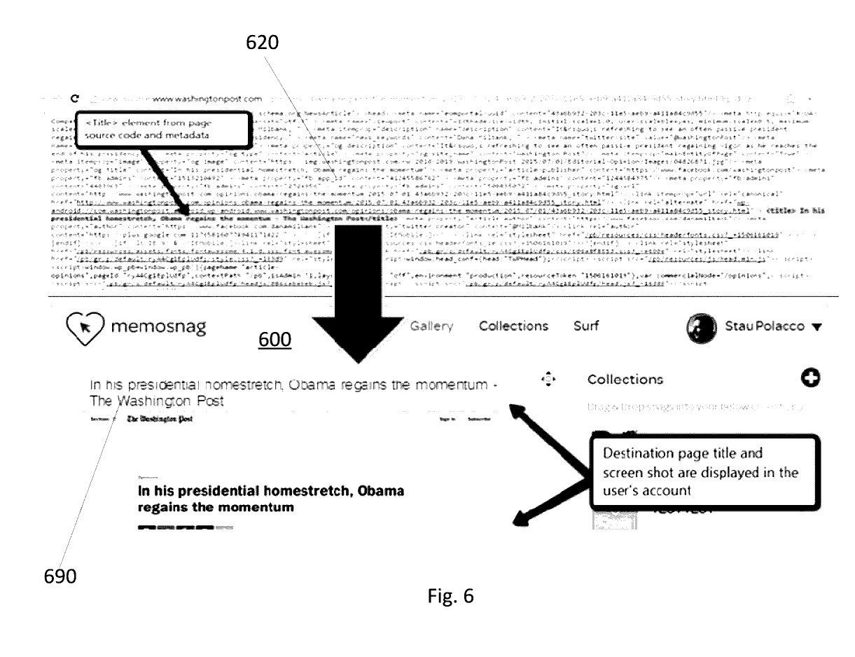

FIG. 6 illustrates an example interface that identifies a captured webpage's title, from the webpage's metadata, in accordance with certain embodiments. Interface 600 displays a captured webpage. The title of the captured webpage 690 can be derived from the destination webpage's metadata 620, in accordance with certain embodiments of the present invention.

The destination webpage's URL may also be embedded in the displayed title 690 so that, by clicking on the displayed title 690, a user may be redirected to the destination web page.

With regard to capturing an e-mail, the full content of an e-mail may be captured by certain embodiments of the present invention. For example, by forwarding the email to an application of certain embodiments (such as, for example, the “memosnag application”), a user may capture the content of the e-mail. When setting up an account such as, for example, a “memosnag account,” a user may provide an email address that is associated with the account. The user can also connect other email addresses to the same memosnag account (subject to email verification). The association of email addresses to memosnag accounts in the memosnag database allows the application of certain embodiments to know which email addresses are connected to each user account.

When a user wants to capture the content of an email and provide the captured content to the user's memosnag account, the user may forward the email to a particular e-mail address such as, for example, to “emails@memosnag.com.” Upon receipt of an email, the application may identify the sender based on the sender's email address. If the sender's email address is found among the known and validated email addresses that are associated to an account, then the content of that email may be saved in its entirety in the corresponding user account as an HTML file and rendered in the user account.

The captured content may be made available to the user in the user's own personal memosnag account, in a dedicated view called a “Gallery” of the account. In certain embodiments, the saved content may be displayed in a social-media-like infinite stream, which may display the saved content in its entirety. When text is saved, the text itself may be displayed. Any text that extends beyond a certain length (such as 50 characters) may be truncated (into, for example, 50 characters), but the user can expand the post to view the text in its entirety.

When an image is saved/captured, the image itself may be shown. When a web page is saved, a screenshot and a title of that webpage may be shown. As such, certain embodiments may allow the user to immediately know the content that he/she is interacting with, without requiring the user to open files outside of the application of certain embodiments.

In view of the above, certain embodiments may enable a user to seamlessly capture, store, and retrieve different types of content. Certain embodiments may capture text, images, videos, and/or links and uniform resource locators (URLs). The previous approaches for capturing images generally required a user to perform a plurality of accompanying steps, which can be cumbersome and time-consuming.

As described above, in addition to providing a first benefit of enabling a user to capture, store, and retrieve different types of content, certain embodiments may provide a second benefit of deriving and generating/creating a citation for the captured content. The citation may be automatically derived/created by using metadata that is associated with the captured content, as described in more detail below. For example, if a user captures content from a webpage, certain embodiments may use the webpage's metadata to derive/create a citation for the content. As such, certain embodiments may automatically determine citations for content derived from online and electronic sources.

For example, when performing academic research, students and researchers may wish to create citations for content, where the content is derived from electronic sources. For example, students and researchers may wish to determine citations for online content. The students may wish to include citations as a part of the students' research work. However, the process of creating citations that reference online content may be a tedious and time-consuming task for the student.

In view of the above difficulties, certain embodiments of the present invention may be directed to a method for automatically and quickly generating citations. The citations may be generated at the time a user captures the content. For example, the citations may be generated when a user captures content with a browser plug-in (such as a “memosnag browser plug-in,” for example).

To generate a citation for content of an online source, certain embodiments may search for relevant details that correspond to the captured content. The relevant details may be within the metadata of the online source from which the content was captured. Specifically, certain embodiments may search for relevant details within the source code of a webpage, for example. The relevant details may be searched for using specific rules (which may be configured in accordance with a specific logic and a specific sequence of steps, as described in more detail below).

Certain embodiments of the present invention may utilize a script that executes a sequence of actions for retrieving certain relevant details. The retrieved relevant details may then be used for generating the citations. The relevant details for generating the citations may include, but are not limited to: (1) author of the content; (2) date of the content; (3) publisher of the content; (4) name of the content; (5) date that the content was captured; and/or (6) web URL of the webpage from where the content was found. The logic and sequence for identifying each of these types of relevant details (from the metadata of a source) is described as follows.

In order to determine the relevant details of captured content (where the captured content is from an online source), certain embodiments may search through the metadata of the online source to determine the portion of metadata that displays or corresponds to the captured content. Certain embodiments may then search for relevant details in the vicinity of the portion of the metadata that displays/corresponds to the captured content. For example, in order to determine the author of an image, certain embodiments may first search for the portion of metadata that displays the image. Certain embodiments may then search immediately above (or immediately below) the portion of metadata that displays the image in order to find other metadata that indicates an author of the image.

To determine the author of a specific captured content within an online source, certain embodiments may search for different keywords/tags within the metadata/source code of the online source that corresponds to information about the captured content. Because the author may be associated with a variety of possible keywords/tags, certain embodiments may first search for the keywords/tags that are most commonly associated with the author. If the keywords/tags that are most commonly associated with the author cannot be found within the metadata/source code, certain embodiments may then search for the keywords/tags that are second-most commonly associated with the author, and so on.

The following is an example method for determining the author of a specific content. The keywords/tags used within the example method are merely example keywords/tags which may be replaced and/or interchanged. Specifically, to determine the author of the specific content, certain embodiments may search for metadata/source code in the form of “author”:“name”. If metadata/source code in the form “author”:“name” is found, then the “name” may be used as the author of the content. If metadata/source code in the form “author”:“name” is not found, certain embodiments may then begin search for metadata/source code in the form of <meta name=“author” content=“name”>.

If metadata/source code in the form of <meta name=“author” content=“name”> is found, then the “name” may be used as the author of the content. If metadata/source code in the form of “<meta name=“author” content=“name”> is not found, certain embodiments may then begin search for metadata/source code in the form of <span itemprop=“name”>.

If metadata/source code in the form of <span itemprop=“name”> is found, then the “name” may be used as the author of the content. If metadata/source code in the form of <span itemprop=“name”> is not found, certain embodiments may then begin search for metadata/source code in the form of <meta name=“byl” content=“by name”/>.

If metadata/source code in the form of <meta name=“byl” content=“by name”/> is found, then the “by name” may be used as the author of the content. If metadata/source code in the form of <meta name=“byl” content=“by name”/> is not found, certain embodiments may then begin search for metadata/source code in the form of <meta name=“by” content=“by name”/>.

If metadata/source code in the form of <meta name=“by” content=“by name”/> is found, then the “by name” may be used as the author of the content. If metadata/source code in the form of <meta name=“by” content=“by name”/> is not found, certain embodiments may search for metadata/source code in the form of <cite> by name </cite>.

If metadata/source code in the form of <cite> by name </cite> is found, then the “by name” may be used as the author of the content. If metadata/source code in the form of <cite> by name </cite> is not found, certain embodiments may use “publisher” data as the author of the content, as described in more detail below.

Although determining the author of content is specifically described above, certain embodiments may use a similar method to determine a date of content. For example, to determine the date of the content, certain embodiments may search for metadata/source code in the form of “datePublished” content=“date”. If metadata/source code in the form of “datePublished” content=“date” is found, then the “date” may be used as the date of the content. If metadata/source code in the form “datePublished” content=“date” is not found, certain embodiments may begin search for metadata/source code in the form of “datePublished”: “date”.

If metadata/source code in the form “datePublished”: “date” is found, then the “date” may be used as the date of the content. If metadata/source code in the form “datePublished”: “date” is not found, certain embodiments may search for metadata/source code in the form of <time itemprop=“datePublished” . . . >.

If metadata/source code in the form <time itemprop=“datePublished” . . . > is found, then the “datePublished” may be used as the date of the content. If metadata/source code in the form <time itemprop=“datePublished” . . . > is not found, certain embodiments may begin search for metadata/source code in the form of “pub_date”: “date”.

If metadata/source code in the form “pub_date”: “date” is found, then the “date” may be used as the date of the content. If metadata/source code in the form “pub_date”: “date” is not found, certain embodiments may begin search for metadata/source code in the form of “article:published_time” content=“date”.

If metadata/source code in the form “article:published_time” content=“date” is found, then the “date” may be used as the date of the document. If metadata/source code in the form “article:published_time” content=“date” is not found, certain embodiments may use the current year as the date of the content.

With regard to the publisher of the content, if publisher data was already used in place of the author of the content, as previously described above, then certain embodiments may avoid including additional information about the publisher. Otherwise, if publisher data has not been used yet, certain embodiments may search for metadata/source code in the form of “publisher”: “publisher_name”. If metadata/source code in the form of “publisher”: “publisher_name” is found, then the “publisher_name” may be used as the publisher of the document. If metadata/source code in the form of “publisher”: “publisher_name” is not found, then a root web URL may be designated as the publisher.

For example, for the URL “http://edition.cnn.com/2015/06/25/world/global-peace-index-iceland-syria/index.html”, the root URL of “cnn.com” may be designated as the publisher of the content at that URL.

With regard to the name of a document, certain embodiments may search for metadata/source code in the form of <title> document_name </title>. If metadata/source data in the form of <title> document_name </title> is found, then the “document_name” may be used as the name of the document. If metadata/source data in the form of <title> document_name </title> is not found, then certain embodiments would not designate a name for the document.

With regard to determining the date that content was captured, certain embodiments may use the current day as the date that the content was captured. For example, certain embodiments may indicate “snagged on Month Day, Year”. Specifically, certain embodiments may indicate that a document was “snagged” on May 14, 2015, for example.

Certain embodiments of the present invention may also utilize the full web URL at which the document was found.

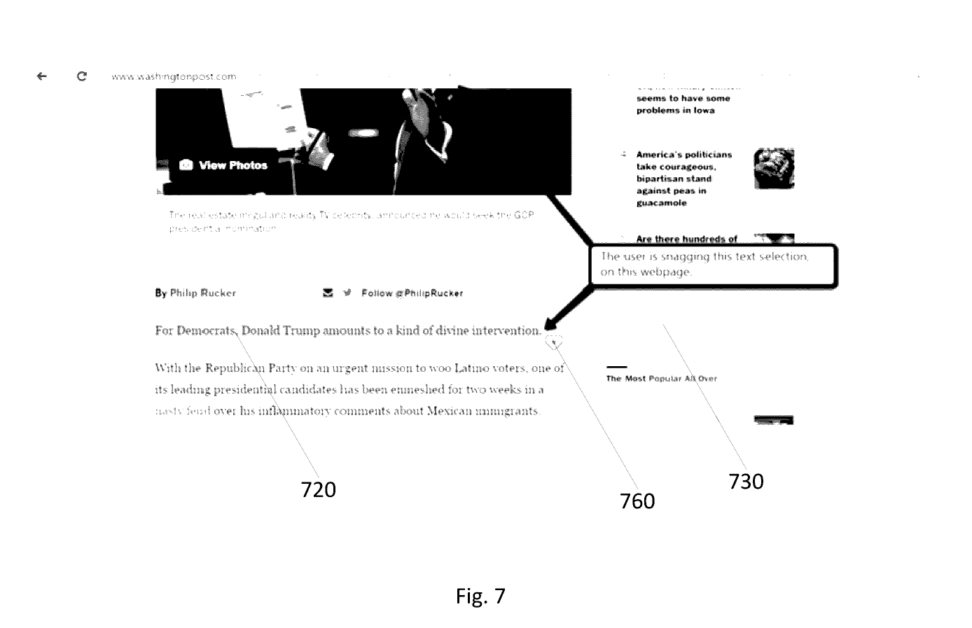

FIG. 7 illustrates an example of how text can be captured, in accordance with certain embodiments. In a first example, the user may wish to capture (may wish to “snag”) a portion of a text 720 from a Washington Post online article. Suppose the article can be found at the following URL: http://www.washingtonpost.com/politics/donald-trump-surges-and-democrats-cheer/2015/07/01/895d9e9e-1f5d-11e5-84d5-eb37ee8eaa61_story.html?hpid=z1. The captured text 720 may be captured after an icon/logo 760 (such as a “memosnag” logo) is clicked. After the text 720 is captured, a citation may be automatically created/generated. After the portion of the text 720 is captured, the captured text may appear in an interface 730 of the application.

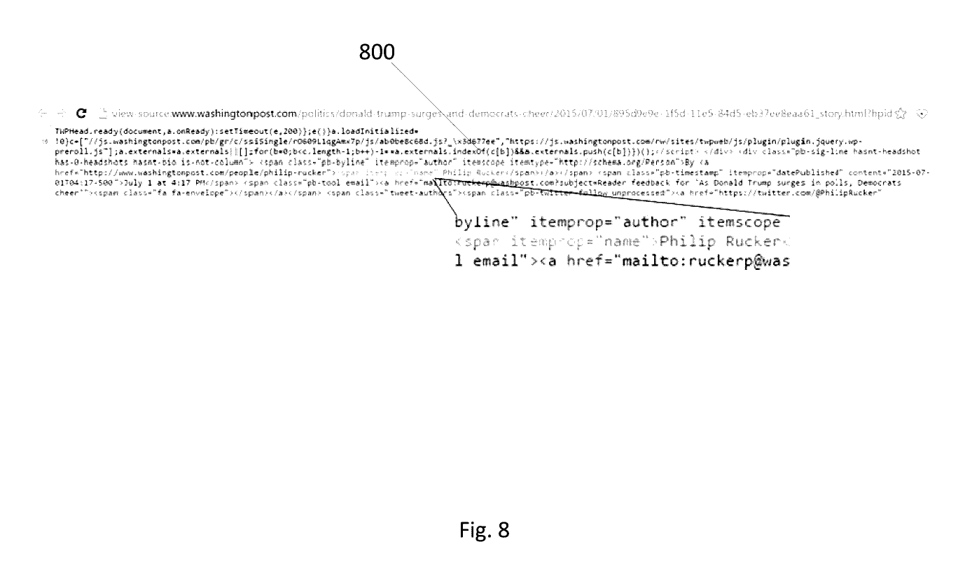

FIG. 8 illustrates an example of identifying an author, in accordance with certain embodiments of the present invention. Upon clicking on a “memosnag” logo 760 of FIG. 7, an application of certain embodiments of the present invention may capture/save the portion of the online text 720 that was selected, and may retrieve the page source 800 corresponding to the online article shown in FIG. 7. The application retrieves the page source 800 of the online article in order to capture the metadata that is needed for creating a citation for the online article. With this first example, the author may be identified using the <span itemprop=“name”> tag as being Philip Rucker.

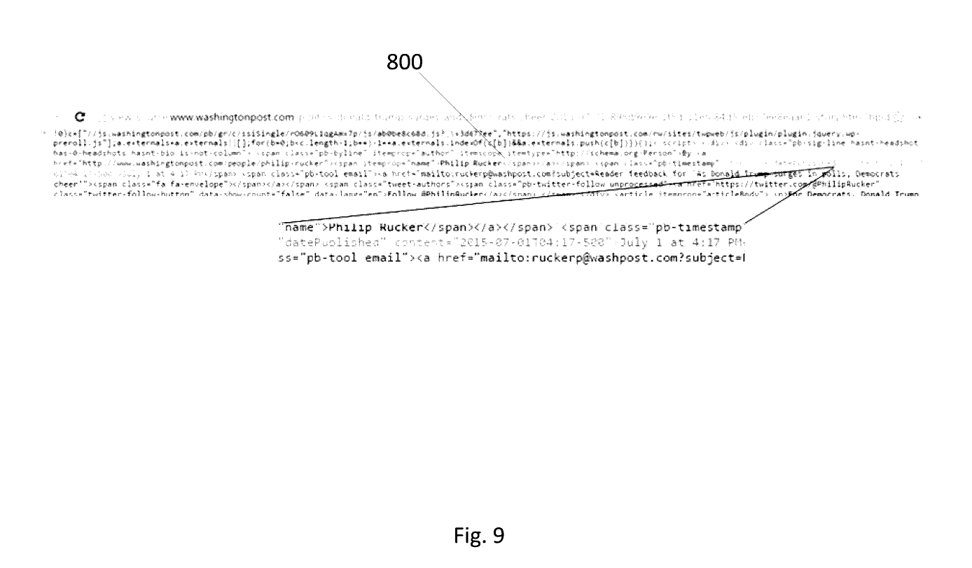

FIG. 9 illustrates identifying a publication date, in accordance with certain embodiments of the present invention. Similar to identifying an author of the captured online text 720, a publication date may also be identified. The publication date may be identified by referencing the page source 800. The published date may be identified with the “datePublished” content=tag as being Jul. 1, 2015.

With this first example, suppose the publisher element is not found within the metadata. As such, the root url may referred to as the publisher. As such, because the Root url for this web page is washintonpost.com, “washingtonpost.com” may be utilized as the publisher.

Further, with this first example, the Document Name may be identified with the <title> tag as being “As Donald Trump surges in Polls, Democrats cheer—The Washington Post.” Further, with this first example, the Date of the document may be identified as being today's date (i.e., the current date). Finally, the web URL of the online article may be identified and captured.

Therefore, with this first example, certain embodiments may combine the above information to generate a resulting citation as:

Philip Rucker|Jul. 1, 2015|washingtonpost.com|As Donald Trump surges in Polls, Democrats cheer—The Washington Post|Snagged on Jul. 2, 2015
Web url: http://www.washingtonpost.com/politics/donald-trump-surges-and-democrats-cheer/2015/07/01/895 d9e9e-1f5d-11e5-84d5-eb37ee8eaa61_story.html

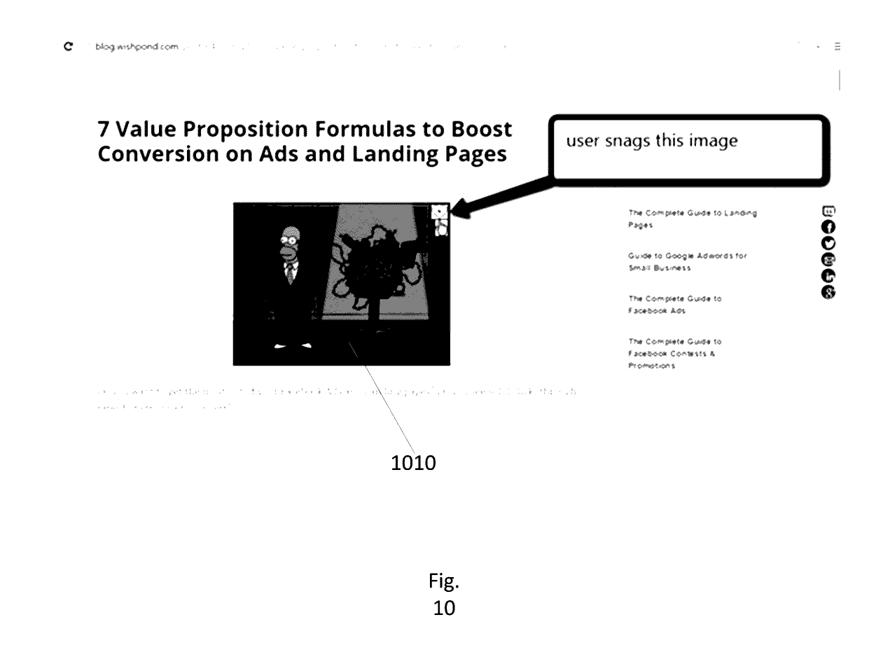

FIG. 10 illustrates an example of capturing/snagging an image from a blog, in accordance with certain embodiments. In the second example of FIG. 10, suppose that a user is capturing/snagging an image 1010 from a post of the wishpond blog. Suppose that the post can be found at the following url: http://blog.wishpond.com/post/64583672563/7-value-proposition-formulas-to-boost-conversion-on-ads.

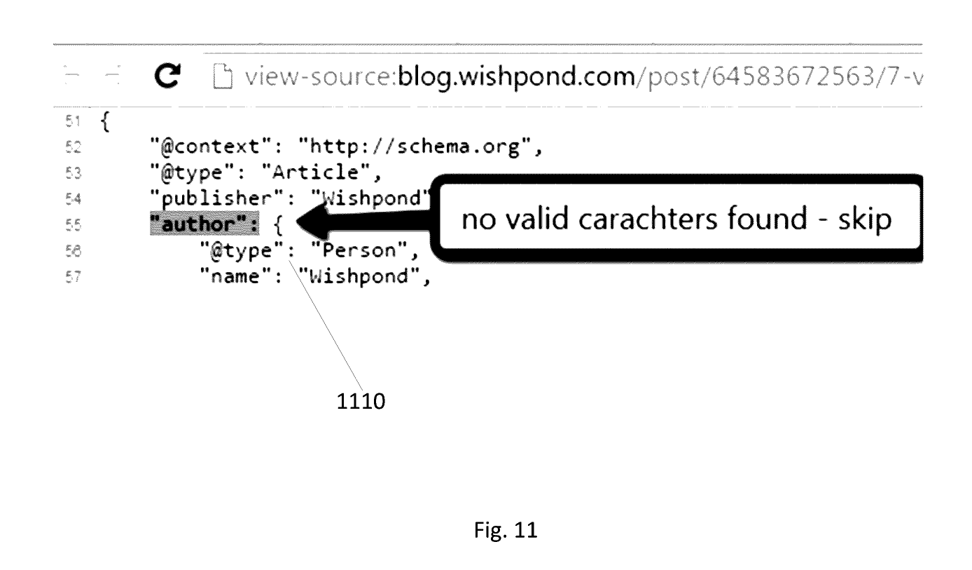

FIG. 11 illustrates an example where no author can be found, in accordance with certain embodiments. With this second example relating to the image 1010 of FIG. 10, suppose that the Author is not found in the metadata. In accordance with the above-described method of identifying the author, the first step is to look for the “author:” tag. Although this tag is found within the metadata corresponding to the image 1010 of the blog post, there are no valid characters associated to the “author” tag. In order for the metadata to identify the author, a name of the author must contain at least 2 consecutive alphabetical characters in order to be identified as a name of the author.

Therefore, the method of identifying the author will logically refer to the next alternative metadata to identify the author. However, the next alternative metadata for identifying the author, as well as all other alternative for identifying the author are not found in the source code 1110. As such, in accordance with the above-described method, because the author is not found, the method will identify the Publisher in place of the author.

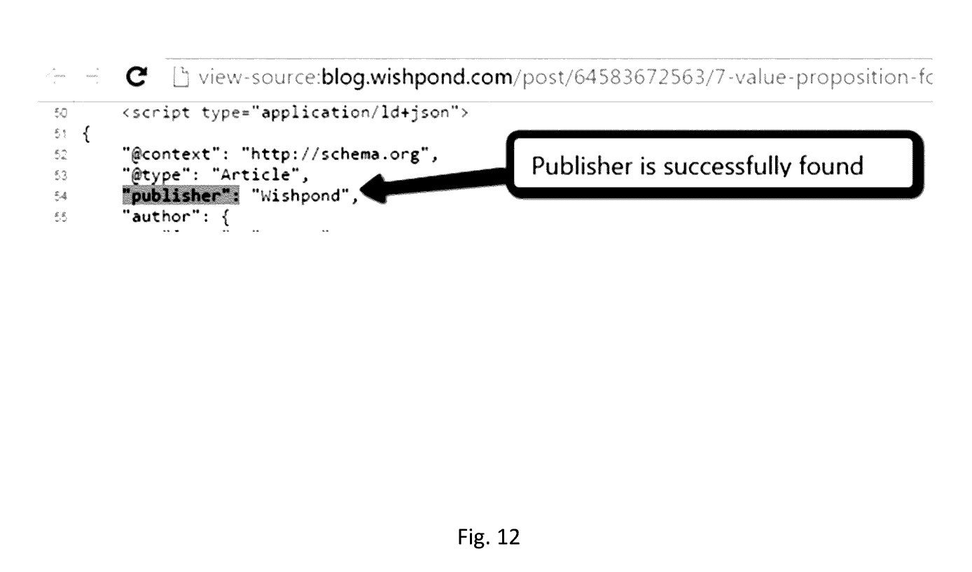

Therefore, the next step of the method is to look for the Publisher. FIG. 12 illustrates an example where a publisher is identified, in accordance with certain embodiments. The method may identify the Publisher by referring to the “publisher:” tag, and thus the method identifies the publisher as “Wishpond”.

With this second example, the publication date may be identified with the “datePublished:” tag as being Oct. 20, 2013. Further, with this second example, because the Publisher was already referenced in place of the author, certain embodiments may avoid referencing the Publisher again, in order to avoid including redundant information in the generated reference.

With this second example, the Document Name may be identified with the <title> tag as being “7 Value Proposition Formulas to Boost Conversion on Ads and Landing Pages.” Further, the date of the document may be identified as being today's date. Finally, the web URL of the blog may be snagged/captured.

Therefore, with this second example, certain embodiments may generate a resulting citation as:

### Wishpond|Oct. 20, 2013|7 Value Proposition Formulas to Boost Conversion on Ads and Landing Pages|Snagged on Jul. 2, 2015.

Web url: http://blog.wishpond.com/post/64583672563/7-value-proposition-formulas-to-boost-conversion-on-ads

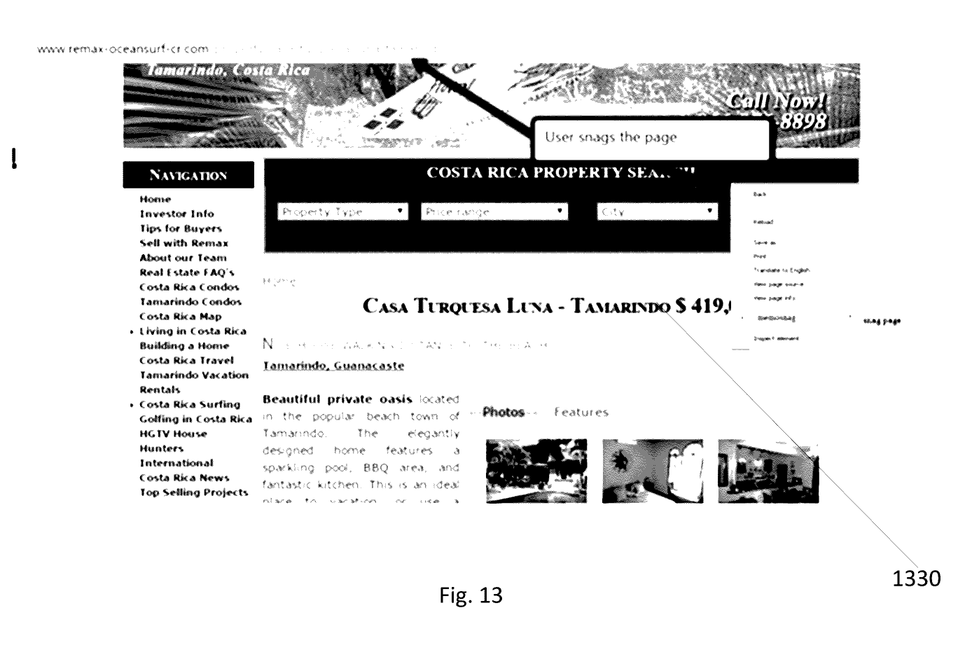

In a third example shown in FIG. 13, a user may wish to capture/snag a listing from the real estate website “Remax.” FIG. 13 illustrates capturing/snagging a listing 1330 from a real estate website, in accordance with certain embodiments. Suppose that the listing can be found at the following url: http://www.remax-oceansurf-cr.com/property/casa-turquesa-luna-tamarindo.

With this third example of FIG. 13, the Author is not found in any of the metadata, with any of the tags that are referenced by the above-described method. This lack of metadata for identifying the author is to be expected because the relevant page is not an article, but rather a listing. Consequently, the method skips over referencing “Author:” and attempts to replace the Author information by using a Publisher. However, with this third example, no Publisher is found in the metadata either, and, in accordance to the logical progression of the above-described method, the root url of the page may be referenced/used. In this third example, the URL of the page is “remax-oceansurf-cr.com.”

Further, with this third example, the date of publication is also not found in the metadata, as expected. Therefore, in accordance with the logical progression of the above-described method, the current year is used (where the current year may be 2015, for example). Further, the method of certain embodiments may avoid referencing the Publisher because the Publisher was already previously referenced in place of the author, in accordance with the logical progression of the above-described method. Further, the Document Name may be successfully identified with the <title> tag as being “Casa Turquesa Luna—Tamarindo $419,000|Remax Ocean Surf Realty Costa Rica.”

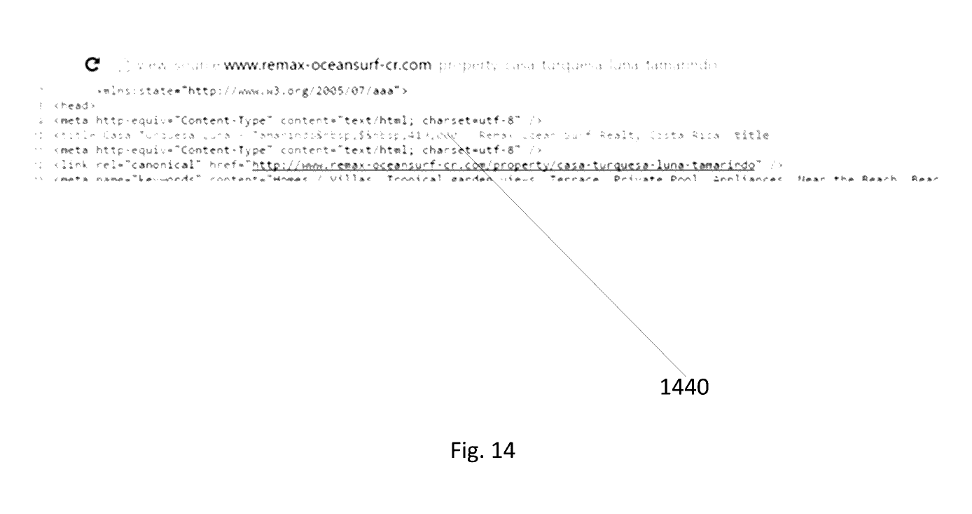

FIG. 14 illustrates an example of identifying a document name of a real estate listing, in accordance with certain embodiments. For example, the document name can be derived from source data/metadata 1440.

Further, the date of the document may be identified as being today's date. Finally, the web URL of the webpage may also be snagged/captured.

Therefore, the resulting citation that is created/generated may be:

remax-oceansurf-cr.com|2015|Casa Turquesa Luna—Tamarindo $419,000|Remax Ocean Surf Realty Costa Rica|snagged on Jul. 4, 2015
Web url: http://www.remax-oceansurf-cr.com/property/casa-turquesa-luna-tamarindo

As discussed above, certain embodiments may provide a third benefit of (3) efficiently organizing captured content. Certain embodiments may provide a simple, intuitive, and flexible method to organize content that is captured by the user.

When the user has saved large amounts of content (on a hard drive or on any other memory device), the user may then have difficulty navigating through the saved content. In order to identify saved content using the previous approaches, users generally relied upon identifying the saved content using specific tags. Users also relied upon self-made file-naming conventions in order to help identify the content of each saved object. Users also named folders using specific names in order to help in identifying the content of saved objects. However, all of these previous approaches generally relied upon specific naming conventions of the users, or still relied upon the user to remember what content was saved within each saved object. With the previous approaches, the user generally had to browse through several folders and had to open several files in order to see the content that is stored within each file.

The previous approaches of managing files and of managing content were generally inefficient, time consuming, and unreliable. In view of the difficulties of the previous approaches, certain embodiments of the present invention may manage content by allowing a user to create customized folders. Certain embodiments may provide the user with a simple drag-and-drop functionality that allows the user to move content from one folder to another, while displaying the content of a folder in its entirety. As such, certain embodiments may resolve the need for using file naming conventions. Certain embodiments may also resolve the need for opening files for the purpose of remembering what content was stored in which files, as described in more detail below.

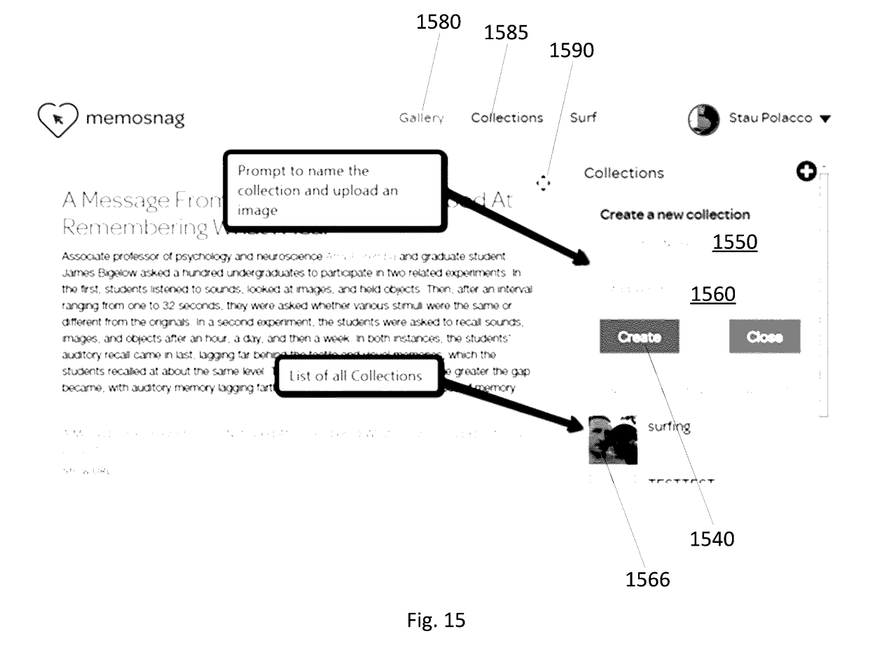

FIG. 15 illustrates an example interface that enables a user to upload an image to a collection, in accordance with certain embodiments. Certain embodiments of the present invention may be directed to a method where a user creates a customized folder (such as a folder named “Collection,” for example). The user folder may be created directly via an interface/screen upon which the content is displayed, after the content is captured. With certain embodiments, the user may click on the “Create Collection” button 1540, and the user may be prompted to name the collection (via box 1550) and to upload an image (via box 1560). Although uploading the image is not mandatory, for certain embodiments, an uploaded image may make it easier for the user to remember what type of content the folder is related to. Once created, collections may be listed underneath the “Create Collection” button 1540.

In certain embodiments, each object of captured content may be provided with an icon 1590 in the top right. The icon 1590 may allow the object of captured content to be grabbed. On mouse over, the pointer/cursor may change into the shape of a hand in order to show the user that the object can be grabbed from its current location. Upon clicking on the object, the object may be grabbed, and the user can drag the object over to the collection that the user wants to move the object into. The user may drop the object by releasing the mouse button. Upon releasing the mouse button, the object may be saved into the collection and may be no longer listed in a general Gallery 1580. The general Gallery 1580 may be the location where the captured content is initially placed/stored within the user's account.

Certain embodiments of the present invention may display the captured content in the form of an updating stream of content, similar to an infinite stream utilized by certain social-media sites. The steam of content of certain embodiments may allow the user to immediately perceive the content that the user is interacting with, without requiring the user to open files outside of the application that captures the content (i.e., the memosnag application).

Certain embodiments may allow a user to create customized folders (referred to as “collections” 1585, for example), and each customized folder may be identified by a name and/or an image.

Certain embodiments may allow a user to view all of the folders that have been created. The folders may be displayed on a screen/interface that is the same as on which the content is stored. Certain embodiments may provide the user with a simple and intuitive drag-and-drop function that allows the user to move content from an original location (such as the general Gallery) into a specific folder, and also allows the user to move content from one folder to another folder.

Certain embodiments may provide an uploading feature that allows a user to upload content directly into a collection. Certain embodiments may provide a take-photo feature that allows a user to take a photo to be stored within a collection, when the user uses a mobile device.

The user may perform the following process. From the general Gallery 1580 (where the captured content is initially stored), the user may click a “Create Collection” button 1540.

The user may then be prompted to name the collection and upload an image. Once a collection is created, the newly created collection may be listed underneath the “Create Collection” button 1540. The newly created collection may then serve as a repository for captured content, as described above. Both the name and the uploaded image (such as a thumbnail 1566, for example) of the collection may also be displayed.

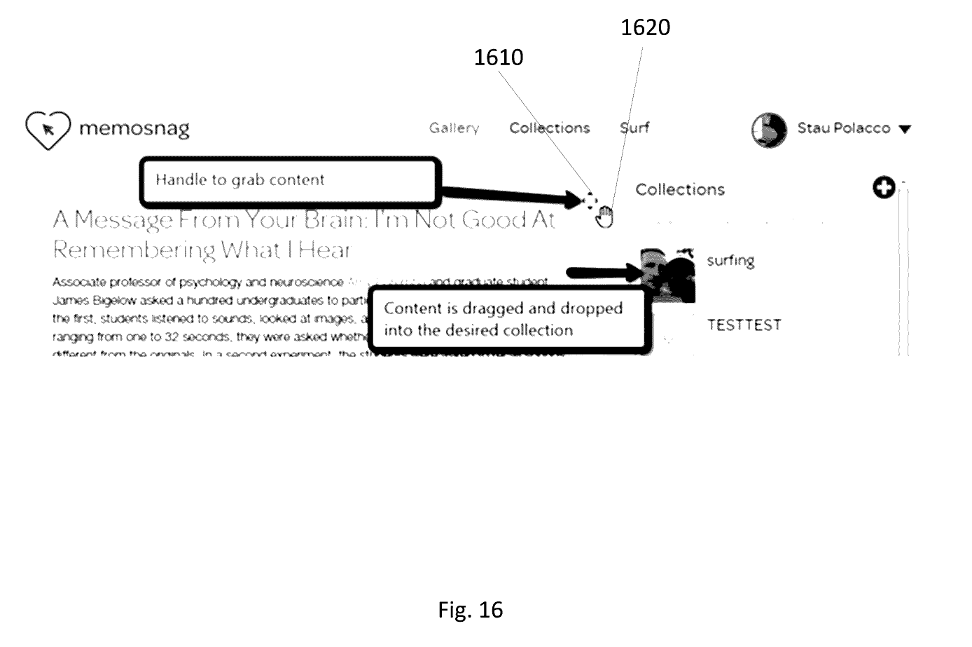

FIG. 16 illustrates an example interface that allows a user to grab content and move the content to a collection, in accordance with certain embodiments of the present invention. To move content from the general Gallery to a specific collection, the user may “grab” the targeted content via a handle 1610 of the targeted content. The user may then drag-and-drop the targeted content to the desired collection. The cursor/pointer may change into a hand 1620 when the cursor/pointer is hovered over the handle. By clicking and holding the cursor/pointer (on the down-click) on the handle 1610, the user may grab the targeted content. The user can then move the targeted content from one collection to another collection, or may move the targeted content back into the general Gallery.

The collections of the user may all be listed on a right side of a page in a dedicated “Collections” section. Collections may be clickable. A user may click into a collection, and the user may be directed into a corresponding collection screen.

The user may also view the list of collections that the user has created. The user may also join a list of collections, as described in more detail below. The user may also view the list of collections that the user has joined. The user may also share the user's collections with other users. The user may view both the collections that the user has created and the collections that the user has shared by clicking on the “Collections” link in the menu bar, at the top of a page, for example.

If the user clicks into a collection from either the collection section or the collection screen, the user may be directed to the clicked collection. The layout of each collection page may be similar to the general Gallery, but the content found within each collection may be the content that the user has moved from the general Gallery (as explained above) or that has been uploaded to that specific Collection. The name and the thumbnail that are specific to each collection may be displayed at the top of the displayed page, enabling the user to easily recognize which collection the user is currently viewing.

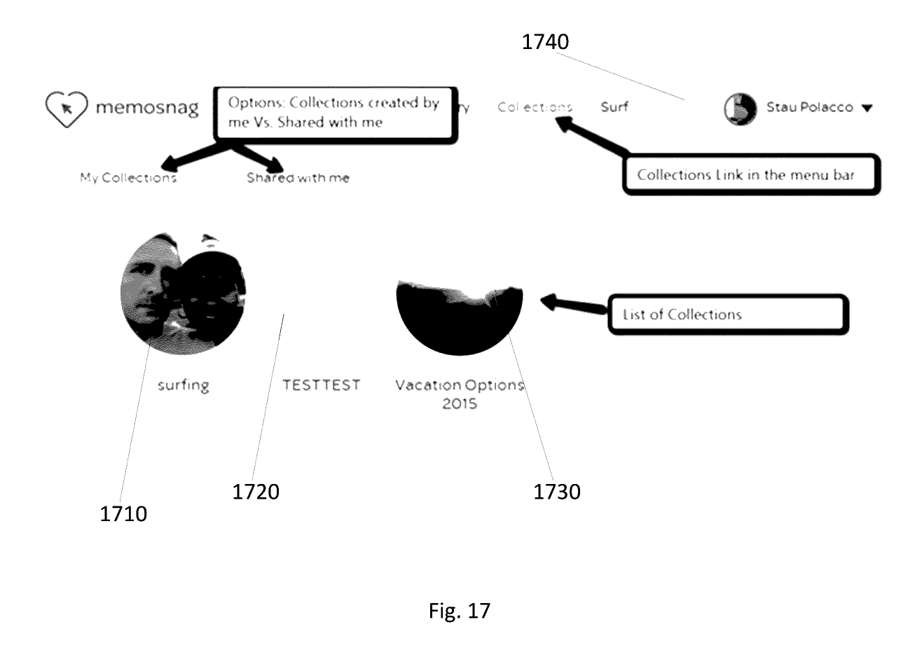

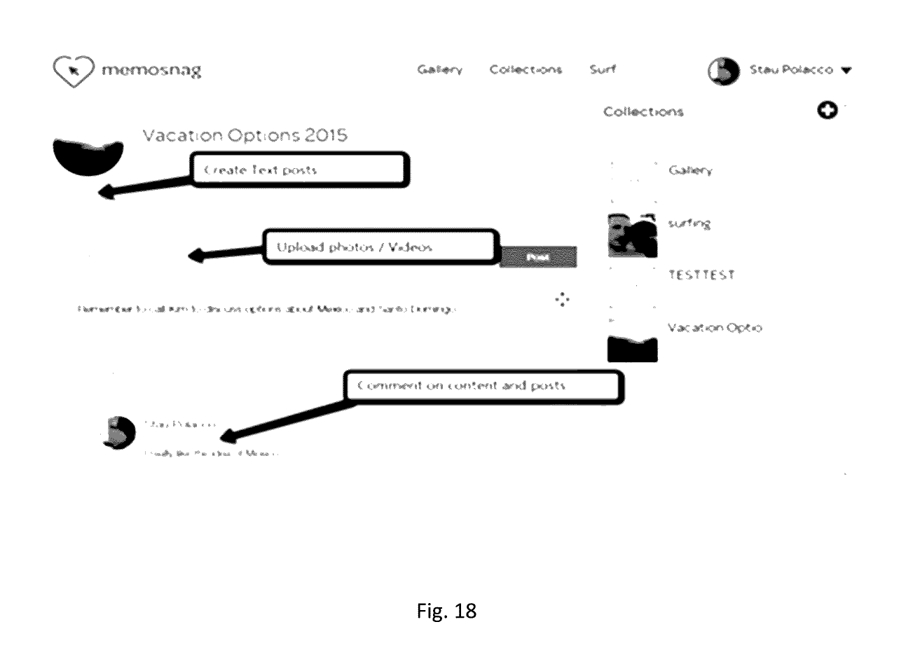

FIG. 17 illustrates an example interface that enables a user to view a list of collections, that the user created or that were shared with the user, in accordance with certain embodiments. Referring to FIG. 17, a user may view the different accessible collections. For example, the user can access a “surfing” collection 1710, a “TESTTEST” collection 1720, and a “Vacation Options 2015” collection 1730. From within the page corresponding to a collection, the user may upload additional content (such as photos and videos, for example) to the corresponding collection. Further, certain embodiments may allow a user to search through the collections (1710, 1720, 1730) for specific content. The users may be able to enter search terms/keywords via a search toolbar 1740, for example. Certain embodiments may include computing logic that allows a user to search by keyword through all the content that the user and/or other users have captured. The search results may be content that the user and/or other users have already identified as relevant or interesting. Such computing logic may generally be referred to as a “user generated content relevance” logic. In other words, suppose a user searches though the content with a keyword “dogs.” In certain embodiments of the invention, the search will yield content that is related to dogs that the user or other users have previously determined to be interesting by virtue of having captured the content in the first place. FIG. 18 illustrates an example interface that enables a user to upload content and create text posts, in accordance with certain embodiments. From within the page corresponding to the collection “Vacation Options 2015,” the user may also create text posts, and may also comment on posts and content relating to the collection.

A user may also be using a mobile device. The user that uses the mobile device may use a “memosnag mobile application,” for example. By using this mobile application, a user may take a photo and directly store the photo within a page that corresponds to a collection. The photo may be automatically saved within that collection as an independent post.

As discussed above, certain embodiments may provide a fourth benefit of enabling users to share and collaborate on a collection of captured content. When a group of people are working on a project, they often need to share the content that they each come across. Each member of the group may want to share the content that each member comes across with the rest of the group members. Each member of the group may want to share content in real time while maintaining visibility of the content that has already been gathered. By enabling the sharing of content, certain embodiments may allow the group to avoid duplication of effort.

The group members may also want to comment on and discuss the content that is shared in real time. The group members may also want to add content for direct comparison with the content that is already collected and previously shared. For example, students that are working on a school project may gather content that they come across that may be useful to the school project. The students may need to make the gathered content available to the group.

Each student that is working on the school project may wish to see what the other students are working on, so that they may avoid duplication of efforts. Further, if the students gather content that is contradictory to other content (where, for example, different gathered content offers differing factual interpretations), the students may need a way to simply compare what they came across and to discuss contradiction, in real time. The students may also need others to be restricted from viewing the students' work process (for example, the students may want to keep their research process secret from other groups that are in competition with them).

In view of the above-described difficulties encountered by users desiring to share content, certain embodiments of the present invention provide a group sharing functionality that is easy to use, and the group sharing functionality may enable all users in the group to capture/snag, load, and share the content in real time. Certain embodiments may also enable snags-specific and post-specific discussion streams.

Certain embodiments may allow a user to share a collection (of gathered content) with other users by allowing the user to invite the other users to view the shared collection. As such, certain embodiments provide users with the ability to share a collection with a limited group of people. In certain embodiments, a shared collection is not public, and the shared collection is accessible only by the users that are specifically invited to view the shared collection.

Certain embodiments may provide users with the ability to search for existing users by name, and certain embodiments may allow users to invite the existing users to view a shared collection.

Certain embodiments may also provide users with the ability to invite users who are not currently using an application of certain embodiments to view a shared collection. These users who are not currently using memosnag may be invited via email.

The users who are not currently using the application of certain embodiments (such as a “memosnag” application) may receive an email which asks them to sign up with memosnag to access the shared collection. All invited users may be able to capture/snag online objects, upload new content, and post text to a shared collection. All invited users may also be able to comment on content that is captured/snagged, uploaded, or posted by other users, as well as content that is snagged, uploaded, or posted by themselves.

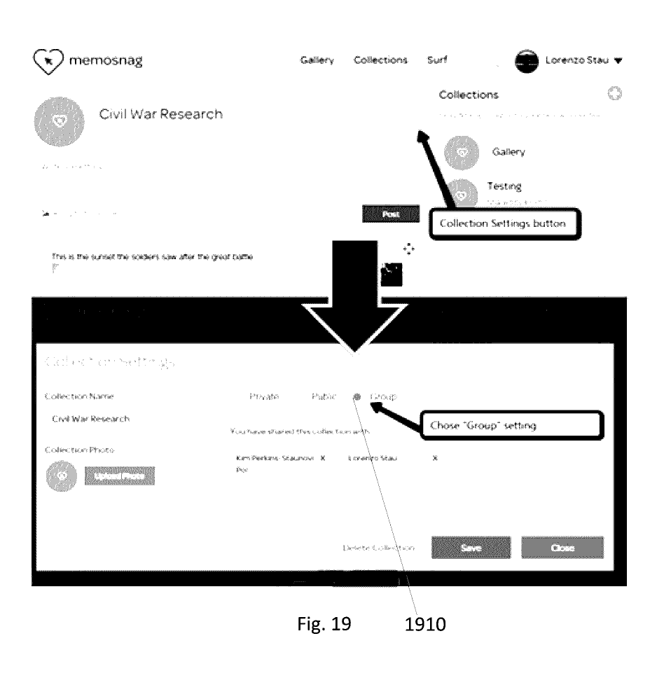

FIG. 19 illustrates an interface that allows a user to share a collection with a group of other users, in accordance with certain embodiments of the present invention. In certain embodiments, the process that is followed by the user may proceed as follows. From a Collection screen, the owner of a Collection clicks the Collection setting button. The owner may set the privacy setting to “Group” 1910. This interface allows the user to invite selected people to the Collection, while keeping the Collection hidden from all other users. The owner of the collection may then click the share button, which opens an overlay where the owner can search for existing memosnag users by name. The owner may select the memosnag users that the owner wishes to share the collection with, and the owner may even invite invitees who are not memosnag users to join memosnag and to access the collection. Invited users may receive an email that informs them of the invitation, along with a clickable link to accept the invitation. For non-memosnag users, the link may first direct them to a signup page. Upon clicking the link (and completing the sign-up process for non-memosnag users), the invitee may gain access to the Collection.

Having accepted the invitation, the invited users are now able to drag-and-drop content from their Gallery or from other Collections into the Collection that they have joined. The invited users can also post text directly into the Collection, and can upload images and videos from their device. The invited users may also take and save photos in the Collection through the invited users' mobile device, just like the owner of the Collection is able to do.

Users that are invited to a Collection are, however, generally unable to delete the collection and unable to delete the posts and content that is uploaded by the owner and other users. The Owner of the Collection may have full editorial rights, including the right to delete posts and the right to delete content that is uploaded from the participants.

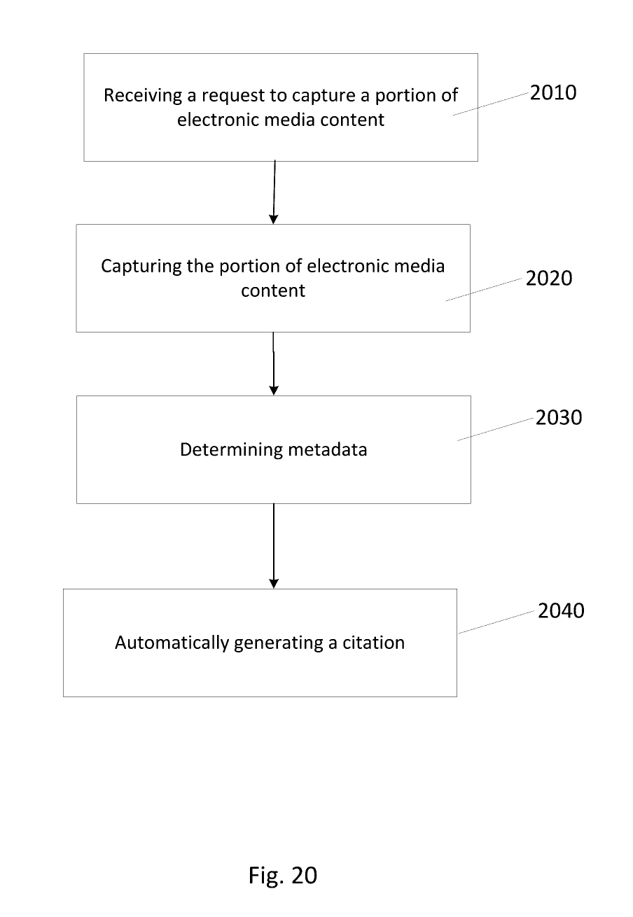

FIG. 20 illustrates an example of a flowchart of a method in accordance with certain embodiments of the invention. The method illustrated in FIG. 20 includes, at 2010, receiving, by a processor, a request from a user to capture a portion of electronic media content from an electronic document. The method may also include, at 2020, capturing the portion of the electronic media content. The method may also include, at 2030, determining metadata of the electronic document that corresponds to the portion of captured electronic media content. The method may also include, at 2040, automatically generating a citation for the captured electronic media content based on the determined metadata. The citation comprises at least one of a title of the captured electronic media content, an author of the captured electronic media content, and a date of the captured electronic media content.

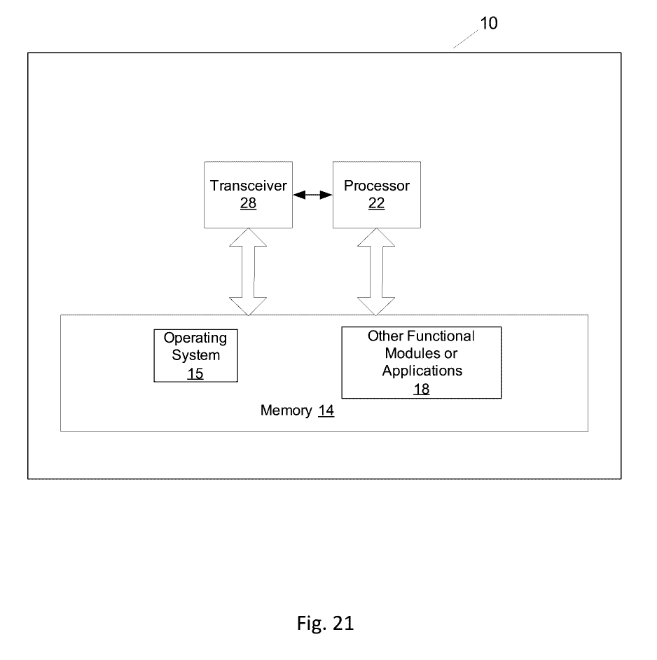

FIG. 21 illustrates an example block diagram of an apparatus in accordance with certain embodiments of the invention. In one embodiment, the apparatus may be a computing device, a mobile computing device, and/or a content viewing device, for example. Apparatus 10 may perform, at least, the method illustrated by FIG. 20. Apparatus 10 may also perform any of the other above-described functionality. As such, apparatus 10 may effect improvements, at least, (1) in the capturing, storing, and/or retrieving of electronic media content, (2) in the generating/creating of citations for the captured content, (3) in the organizing of the captured content, and/or (4) in the sharing of a collection of captured content with others users. Apparatus 10 can include a processor 22 for processing information and executing instructions or operations. Processor 22 can be any type of general or specific purpose processor. While a single processor 22 is shown in FIG. 21, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, preceding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

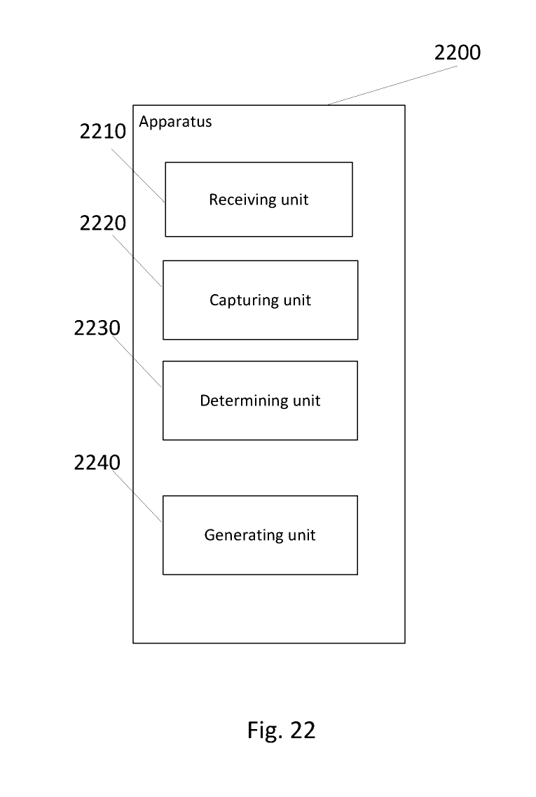

FIG. 22 illustrates an apparatus in accordance with certain embodiments of the invention. Apparatus 2200 can be a computing device, a mobile computing device, and/or a device for viewing electronic media, for example. Apparatus 2200 can include a receiving unit 2210 that receives a request from a user to capture a portion of electronic media content from an electronic document. Apparatus 2200 may also include a capturing unit 2220 that captures the portion of the electronic media content. Apparatus 2200 may also include a determining unit 2230 that determines metadata of the electronic document that corresponds to the portion of captured electronic media content. Apparatus 2200 may also include a generating unit 2240 that automatically generates a citation for the captured electronic media content based on the determined metadata. The citation comprises at least one of a title of the captured electronic media content, an author of the captured electronic media content, and a date of the captured electronic media content.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving, by a processor, a request from a user to capture a portion of electronic media content from an electronic document;
capturing the portion of the electronic media content;
determining metadata of the electronic document that corresponds to the portion of captured electronic media content; and
automatically generating a citation for the captured electronic media content based on the determined metadata, wherein the citation comprises at least one of a title of the captured electronic media content, an author of the captured electronic media content, and a date of the captured electronic media content.

2. The method according to claim 1, wherein the receiving a request to capture a portion of electronic media content comprises receiving a request to capture the portion of electronic media content from a webpage, and the metadata of the webpage comprises source code of the webpage.

3. The method according to claim 1, wherein the title of the captured electronic media content is determined by first referencing <title> metadata, the author of the captured electronic media content is determined by first referencing author:name metadata, and the date of the captured electronic media content is determined by first referencing datePublished content=date metadata.

4. The method according to claim 1, wherein the method further comprises:
displaying the captured electronic media content; and
displaying the automatically generated citation.

5. The method according to claim 1, wherein the method further comprises:
storing the captured electronic media content in one collection of a plurality of collections, wherein each collection is associated with a corresponding image.

6. The method according to claim 5, wherein the method further comprises sharing at least one collection of the plurality of collections to at least one other user.

7. An apparatus, comprising:
at least one processor; and
at least one memory including computer program code,
the at least one memory and the computer program code configured, with the at least one processor, to cause the apparatus at least to
receive a request from a user to capture a portion of electronic media content from an electronic document;
capture the portion of the electronic media content;
determine metadata of the electronic document that corresponds to the portion of captured electronic media content; and
automatically generate a citation for the captured electronic media content based on the determined metadata, wherein the citation comprises at least one of a title of the captured electronic media content, an author of the captured electronic media content, and a date of the captured electronic media content.

8. The apparatus according to claim 7, wherein the receiving a request to capture a portion of electronic media content comprises receiving a request to capture the portion of electronic media content from a webpage, and the metadata of the webpage comprises source code of the webpage.

9. The apparatus according to claim 7, wherein the title of the captured electronic media content is determined by first referencing <title> metadata, the author of the captured electronic media content is determined by first referencing author:name metadata, and the date of the captured electronic media content is determined by first referencing datePublished content=date metadata.

10. The apparatus according to claim 7, wherein the apparatus is further caused to:
display the captured electronic media content; and
display the automatically generated citation.

11. The apparatus according to claim 7, wherein the apparatus is further caused to store the captured electronic media content in one collection of a plurality of collections, wherein each collection is associated with a corresponding image.

12. The apparatus according to claim 11, wherein the apparatus is further caused to share at least one collection of the plurality of collections to at least one other user.

13. A computer program product, embodied on a non-transitory computer readable medium, the computer program product configured to control a processor to perform a method, comprising:
receiving, by a processor, a request from a user to capture a portion of electronic media content from an electronic document;
capturing the portion of the electronic media content;
determining metadata of the electronic document that corresponds to the portion of captured electronic media content; and
automatically generating a citation for the captured electronic media content based on the determined metadata, wherein the citation comprises at least one of a title of the captured electronic media content, an author of the captured electronic media content, and a date of the captured electronic media content.

14. The computer program product according to claim 13, wherein the receiving a request to capture a portion of electronic media content comprises receiving a request to capture the portion of electronic media content from a webpage, and the metadata of the webpage comprises source code of the webpage.

15. The computer program product according to claim 13, wherein the title of the captured electronic media content is determined by first referencing <title> metadata, the author of the captured electronic media content is determined by first referencing author:name metadata, and the date of the captured electronic media content is determined by first referencing datePublished content=date metadata.

16. The computer program product according to claim 13, wherein the method further comprises:
displaying the captured electronic media content; and
displaying the automatically generated citation.

17. The computer program product according to claim 13, wherein the method further comprises:
storing the captured electronic media content in one collection of a plurality of collections, wherein each collection is associated with a corresponding image.

18. The computer program product according to claim 17, wherein the method further comprises sharing at least one collection of the plurality of collections to at least one other user.
